(19) United States
(12) Patent Application Publication
(10) Pub. No.: US 2024/0242224 A1
(43) Pub. Date: Jul. 18, 2024

(54) METHOD AND SYSTEM FOR ENTITY AND PAYMENT RAIL VERIFICATION IN TRANSACTION PROCESSING

(71) Applicant: Verituity, Inc., McLean, VA (US)

(72) Inventors: Jeffrey Chistolini, Arlington, VA (US); Anthony Renzette, Ashburn, VA (US); Christopher Smith, Arlington, VA (US); Benjamin Turner, Bethesda, MD (US)

(21) Appl. No.: 18/409,165

(22) Filed: Jan. 10, 2024

Related U.S. Application Data
(60) Provisional application No. 63/479,791, filed on Jan. 13, 2023.

(51) Int. Cl. G06Q 20/40; G06Q 20/02; G06Q 20/10

(52) U.S. Cl. CPC G06Q 20/4016; G06Q 20/023; G06Q 20/10; G06Q 20/4014

(57) ABSTRACT

A new method for providing security in the context of transaction processing is disclosed. Machine learning is used to detect the potential for fraud and/or errors, select a payee account and payment rail, and initiate the processing of a payment. The method uses a trained payment method selection model to classify one or more of the candidate payment rails as optimal for transaction processing. The method also includes selecting a payee account that is associated with an identified payee and the selected payment rail, The system uses a payee account validation model to validate that the payee account will process on the selected payment rail. The system will then generate payment initialization data and transmit the data to an entity to originate the payment from the payer account to the selected payee account.

### RELATED APPLICATIONS AND CLAIM OF PRIORITY

This patent document claims priority to U.S. Provisional Patent Application No. 63/479,791, filed Jan. 13, 2023, the disclosure of which is fully incorporated into this document by reference.

### BACKGROUND

Prevention of fraud and errors in the electronic processing of payment transactions is a significant issue. According to information published by the United States Federal Trade Commission (FTC), in the year 2021 over 2.8 million consumers reported fraud to the FTC, and those consumers reported losses of more than $5.8 billion due to fraud. Novel approaches to verification are needed to reduce fraud and errors and provide high levels of confidence that a payout transaction will complete as intended. Addressing payment errors in addition to fraud enables payers to achieve their goal of timely, accurate payments.

Many technical approaches to address the issue of fraud exist. Technologies such as multi-factor authentication, artificial intelligence (AI) data analysis tools, device shielding, and IP address verification can help. However, as the FTC data mentioned above shows, these solutions are not yet sufficient to fully address the problem. In addition, because banks in the United States do not typically allow sharing of data via open banking application programming interfaces (APIs), the data available to be used in fraud detection is often incomplete.

Accordingly, improved methods and systems for detecting fraud and errors before completing payment transactions are needed. This document describes methods and systems for addressing these issues.

### SUMMARY

This document describes methods and systems that apply a novel machine learning- based approach to detect anomalies in the relationships of the entities involved in a payment transaction. These anomalies can be markers of errors, fraud or both, and can indicate a higher risk of the transaction failing. Based on the results of the machine learning risk profiles, the methods described in this document can apply additional machine learning tools to select the payment rail(s) that may have high likelihood of success, and to deprecate any payment rails that are more likely to result in a failure of the transaction.

This document describes methods, systems for implementing the methods, and computer program products with instructions to cause a processor to implement methods, in which the methods provide security for a transaction. The method includes, in response to receiving a payee identifier and information about a transaction from a payer: (a) using use the payee identifier to identify a payee risk profile for the payee; (b) entering the payee risk profile, payer preferences, and global rail characteristics into a payment method selection model that has been trained using preferences of the payer; and (c) using the payment method selection model to determine whether one or more of the candidate payment rails match payer preference patterns, and select one of the one or more candidate payment rails to be a selected payment rail. The method also includes: (d) selecting a payee account that is associated with the payee and the selected payment rail; (e) using a payee account validation model to validate that the payee account will process on the selected payment rail; (f) generate payment initialization data that a financial entity can use to complete a transfer of assets from a payer account that associated with the payer to the selected payee account; and (g) transmitting the payment initialization data to the financial entity to automatically originate the payment from the payer account to the selected payee account via the selected payment rail.

### BRIEF DESCRIPTION OF THE DRAWINGS

FIG. 1 illustrates examples of various payment rails for completing electronic transactions between a payer and a payee.

FIG. 2 illustrates various elements of a payment method selection system, and functions that the system may perform to select a payment method with which a digital payment system will complete a transaction.

FIG. 3 is a flow diagram illustrating an example process flow.

FIG. 4 illustrates example components of computing devices that may form parts of the system and/or implement the methods described in this document.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

A payment rail, as is generally known, is a digital pathway by which funds are electronically transferred from an origin to a destination account. Rails facilitate the clearing and settlement process. The relationship between accounts and rails can be one-to-one or one-to- many depending on the type of account. For example, the following rails could be used to move funds between two US-based bank accounts: The Clearing House's ACH network rail (known as EPN); The Clearing House's RTP network rail; or the US Reserve Banks' ACH network rail.

The choice of rail will impact the security of the payment, timing of the payment's settlement, and processing cost of the payment transaction.

Additional terms that are relevant to this disclosure will be defined at the end of this Detailed Description section.

This document describes methods and systems that employ novel machine learning, risk profiling, and optimization techniques to address the unique verification and security challenges that financial institutions face when processing electronic payments. The methods also address payment errors, which can help payers achieve a goal of timely, accurate digital payments. The methods described below identify and assess relationships and interactions between the various entities associated with the payment (such as payee, payer, payment account, and payment rail) to identify anomalies that can be indicators of fraud, errors or both. The system also uses one or more trained machine learning models to select a payment rail that matches the payer's preferences for processing costs, transaction speed, and risk.

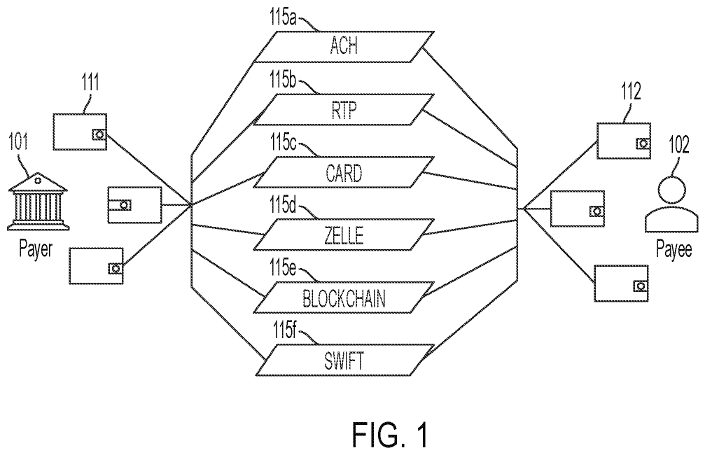

FIG. 1 illustrates examples of various paths for completing electronic transactions between a payer 101 and a payee 102. The paths, which are generally known as payment rails 115a-115e, are each a platform and/or network infrastructure that enables digital money transfers between payer accounts 111 and payee accounts 112 of businesses, individuals, or a combination of the two. As noted above, examples of payment rails include those of the Automated Clearing House (ACH) network 115a, the Real-Time Payments (RTP) Network 115b, the rails of credit card providers 115c such as Mastercard and Visa, the Zelle network 115d, blockchain-based networks 115e which are typically used for the transfer of cryptocurrency, and the Society for Worldwide Interbank Financial Telecommunication (SWIFT) payment network 115f. Other payment rails such as those of the Single Euro Payments Area (SEPA), PayPal, Venmo, and the Fedwire Funds Service may be included in various embodiments.

As FIG. 1 illustrates, a payer 101 may hold multiple payer accounts 111. A payee 102 also may hold multiple payee accounts 112. Several different payment rails 115a-115fmay be available to transfer funds between any of the payer accounts 111 and any of the payee accounts 112. Some accounts, payment rails, or combinations of the two may expose a transaction to a greater level of risk than others. The methods and systems described in this document address the challenges of selecting accounts and payment rails for digital transactions to enable secure and successful processing of digital payments, and to help reduce the risk of fraud and errors.

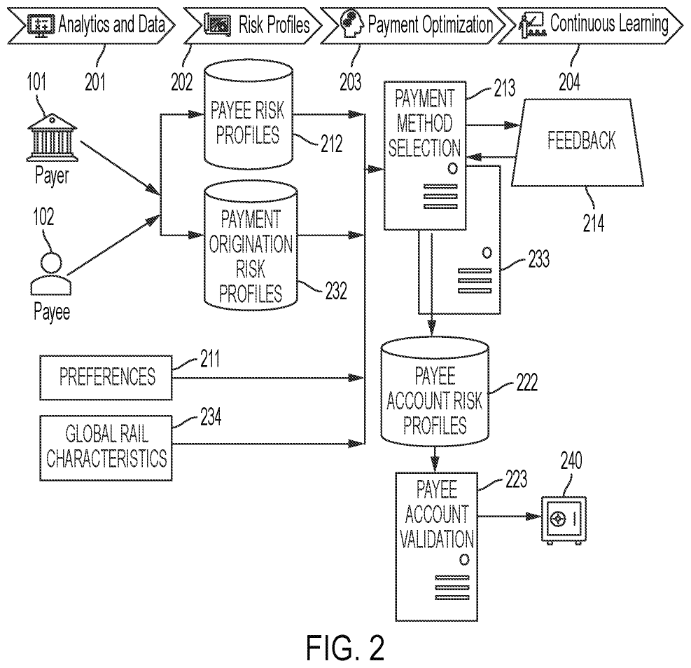

FIG. 2 provides a high-level overview of certain elements of the system, and functions that the system may perform, to select a payment method with which a digital payment system will complete a transaction. At a high level, the system will use certain data and analytics 201 about a payer, payee, and one or more payment methods and use that data and analytics in subsequent functions. The data and analytics may be stored in a data store or received upon initiation of a payment transaction request by a payer 101, a payee 102, or a third party. The transaction request will include a payment amount, will identify the payer 101 and payee 102, and may include other information such as constraints or other preferences 211, as will be described below.

The system will use risk profile models to create and maintain risk profiles 202 for various participants in the system. A risk profile model is a machine learning model that is trained with the objective of, in response to receipt of data, generating and outputting an assessment of risk associated with that data. Each such assessment may be considered to be a risk profile. The risk profile models and/or risk profiles may be managed in a corresponding microservice so that the system securely transfers necessary information from the risk profiles 202 to the payment selection model 213.

The risk profile models may include a payee risk profile model that generates payee risk profiles 212 for various payees who are known to or interact with the system. To build a payee risk profile 212, the system uses a machine learning model. The machine learning model will be trained to predict the likelihood that an impersonator or other entity who falsely claims to be the payee is misrepresenting their personal information in such a way that, if accepted by the system, the payment would go to that entity and not to the genuine, intended payee. When the payee is a business entity, the machine learning model may evaluate both (1) if the business is a legitimate business entity and (2) if the person registering the business is legitimately associated with the business in a position to register the business and establish payment information on the platform. Suitable modeling techniques for payee risk profile development include, but are not limited to, voting-based ensemble modeling. Ensemble modeling combines various models developed using different supervised machine learning techniques such as logistic regression, decision trees, and/or neural networks. Ensemble modeling also may include combining several models that are each developed using a single technique. When combining the models, the system may employ known methods such as boosting, bagging, or stacking to improve the training and performance of the overall ensemble. The model or models may be trained on data that is labeled based on feedback from financial institutions and/or payers about the processing of previous payments, and/or other actual or synthetic data.

Data that a payee risk model may ingest to develop a payee risk profile 212 include information such as: (i) a ratio or other measurement of how closely a relationship key provided by the payer matches what the payee provided; (ii) a ratio or other measurement of how closely data provided by the payer about the payee (such as full name or address) matches data that the payee provided; (iii) data from the payee's web browser client header (such as IP address); (iv) third party consumer data about the payee; (v) information about payee behavior based on past transactions of the payee that are known to the platform; and/or (vi) geographic distance (in the real world) between the payee's expected location and actual current location.

The risk profiles also may include payment origination risk profiles 232 for one or more payers who will initiate the payment. To build a payment origination risk profile 232, the system also may use a machine learning model. The machine learning model will be trained to predict the likelihood that a payment was legitimately originated by a known payer. This can provide an additional layer of security above and beyond user authentication. Suitable modeling techniques for payment origination risk profile development also include, but are not limited to, voting-based ensemble modeling as described above. The model or models may be trained on data that is labeled based on feedback from financial institutions and/or payers about the processing of previous payments, and/or other actual or synthetic data.

Data that a payment origination risk model may ingest to develop a payment origination risk profile 232 for a payer include information such as: (i) the payer's past patterns for payment amounts; (ii) the payer's past patterns for payment timing; (iii) the payer's account funding history (example, how long is the history, are the current funds levels consistent with past patterns, etc.); (iv) a number of successful transactions from the payment origination account; (v) a temporal trend in transactions volumes from payment origination account; and/or (vi) a geographic location of the payment origination request.

The risk profiles described above, along with preference information 211 provided by (or available in a profile of) the payer 101 and/or payee 102, will be fed to a payment method selection model 213. The preference information 211 may include information such as the payer's preferred payment rail(s), identification of payment rails that are supported by both the payer's account and the payee's account, cost and delivery windows associated with use of the payment rail, and a minimum or maximum amount that each payment rail or account permits. The preference information 211 also may include other data, objectives, or constraints.

The payment method selection model 213 is a model that is trained to select one or more payment rails that most closely fit with the payer's preference patterns for managing and/or optimizing timeliness, risk, and cost trade-offs between the rails while reducing risks associated with the transaction. Suitable models for a transaction-level payment method selection model also include, but are not limited to, voting-based ensemble models such as those useful with the other models described above. To train this model, a payer may be shown data for various transactions having different levels of payer risk and performance (such as transaction completion speed and/or cost). The payer can label each transaction with a preference ranking. The payer's responses are then input to the model 213 to train the model to make selections that consider the payer's preference patterns and risk tolerance. Payer feedback on historical transactions in 214 will allow the model to automatically self-learn over time. Rather that empirically looking for distinct matches between input and specific preferences, the model 213 is trained to identify patterns associated with the payer's preferences, and to make selections that are consistent with those patterns.

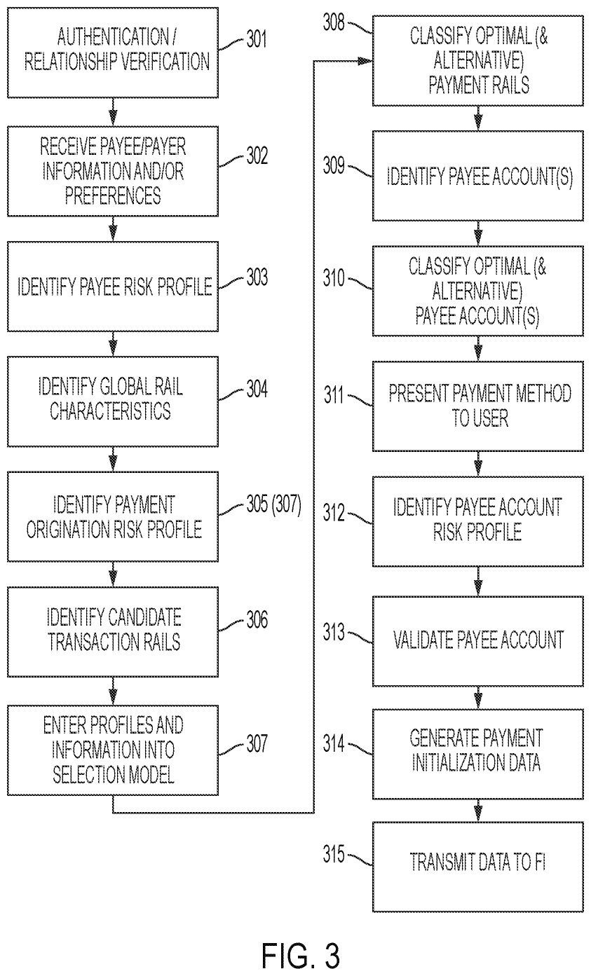

Data that a payment method selection model 213 may use to select a payment rail for a transaction include, as described above: (i) payee risk profiles 212; (ii) payment origination risk profiles 232; (iii) payer (and optionally payee) preference data 211; and/or (iv) global rail characteristics 234 (which are described in more detail below in the discussion of FIG. 3). The payer (or payee) preference data 211, global rail characteristics 234, and/or the payee risk profile 212 may identify or contain information that is relevant to its corresponding entity's preferred payment rails, and the model may consider this data when selecting the payment rail for the transaction.

The previous paragraph describes a transaction-level payment method selection model, that has been trained on a single transaction and thus processes transaction-level data to assess risk associated with, and select a payment rail and account for, a particular transaction. Optionally, if the payer submits transactions in batches, then instead of a transaction-level payment method selection model, the system may use a batch-level payment selection model 233. The batch-level payment method selection model 233 may be similar in structure and function to a transaction-level payment method selection model 213 as described above, except that it will have been trained on batches of transactions, and it will select payee accounts and rails to optimize the payer preferences based on the characteristics of a batches of transactions. For example, the batch model might indicate that more transactions can be sent via RTP than would be indicated by the individual transaction model because the batch as a whole meets the risk objective of the payer.

Once the payment method selection model selects a payment rail, the system identifies one or more accounts for the payee that is (or are) associated with the selected payment rail. Before initiating a transaction or presenting any of the payee accounts to the payer for approval, the system may verify that the payee account will successfully process the payment via this rail. To do this, the system may accesss one or more payee account risk profiles 222 that are associated with the one or more identified payee accounts.

To build a payee account risk profile 222, the system also may use a machine learning model for payee account development and/or validation 223. The machine learning model will be trained to predict the likelihood that a payment will not process successfully for the payee's account. If a payee has multiple available accounts, the system may generate or use a separate risk profile for each account. Suitable modeling techniques for payee account risk profile development also include, but are not limited to, voting-based ensemble modeling as described above. The model will use publicly-available information about the payee such as state business registration data, data published by federal agencies (such as the United States Small Business Administration or Securities and Exchange Commisson), data from one or more Internet profiles for the payee, and other data returned in online searches of public and/or private databases. The model or models may be trained on data that is labeled based on feedback from financial institutions and/or payers about the processing of previous payments, and/or other actual or synthetic data.

Data that a payment account risk model 223 may ingest to develop and/or use a payee account risk profile 222 for a payee account includes information such as: (i) an indication of whether the payee's email ownership information matches the account ownership information; (ii) an overall number of payout failures and/or fraud cases for the payment account; (iii) the recoverability of funds held in the account; (iv) the date that, or the period of time elapsed since, the payee last used account across the platform; (v) IP address consistency when setting up the account compared to other events on platform; (vi) a number of successful payments made to account in the past; (vii) characteristics of (such as the IP address associated with) other payouts made to the account; (viii) geographic location of the payee or the institution that holds the payee's account (for example, is the account based in high-risk country, or is the payee's location inconsistent with the location of the payment account's institution); (ix) any temporal trend in transactions using the account; and/or (x) a number or frequency of account log-in failures and/or attempts when adding the payment account.

Optinally, to validate an account the system also may determine whether a person who is associated with the payment is also associated with the payee. For example, if a payer wants to pay a business entity payee, the payer may provide the system with an email address for the business. That email address may be associated with a person. Optionally, the system may require the person to be pre-registered with the system, and to provide their email address and affialiation with the payee, before the system will send a payment to that email address. The system also may independently verify the person's email and/or other data through online searching of public records, social media accounts, online profiles, and the like.

Once the rail is selected and the payee account validated, the system may transmit the recommendation to the payer, the payee, or both for approval. The approving party may approve the recommendation, reject it, or select an alternate payment method. The system may use the approving party's response as feedback 214 to further train the payment method selection model. The system will then transmit the approved (or alternate) method to a financial institution 240 of the relevant payer account for processing. Feedback 214 may also be collected post hoc so that payers can reduce friction in the system.

Feedback 214 may come from other sources as well. For example, payment rails may provide feedback in the form of status codes. These codes may conform to Nacha, ISO, or other proprietary standards. The system may transform the status codes into a single array of feedback values that are used by the models to continually improve the performance and accuracy of the models that drive verification. Payers, payees, or both also may provide feedback in the form of codes and/or optional narratives to indicate whether the transaction was processed in a manner that suited their preferences.

The system also may receive, from the payer, key-value pairs for one or more payees. Key-value pairs will include data for one or more parameters associated with a transaction, in which the data is that which most entities other than the parties to the transaction are not likely to know. For example, if the payer is an insurance company that is processing a claim, example key-value pairs may be policy number/12345, or claim number/ABCDEFG. The system may enter the key-value pairs into a payee risk profile model (such as a payee account validation model described below) for the payee to generate assessments of whether the payee satisfies one or more risk criteria. The system may solicit feedback 214 from the payer in response to the assessments. In response to receiving the feedback, use the feedback 214 to train the payee risk profile model.

FIG. 3 is a diagram illustrating an example process flow that the system may follow when selecting a payment method for a transaction. The process flow describes various steps and actions that may occur, but the process is not limited to the order shown. Steps may be re-ordered, performed at the same time, or otherwise arranged. In addition, not all steps may be implemented in all variations, and/or additional steps not shown may be added.

At 301 when a payer and/or payee logs on to the system to initiate a transaction, that party will be required to enter an authentication token or tokens to verify their identity. Such tokens may include a username, password, personal identification number, biometric identifier, electronic device ID, a two-factor authentication response, or other identifier. At 301 the system also may verify whether the payer and payee have previously engaged in transactions with each other, which can help formulate more accurate and robust risk assessments. In addition to self- identifying, the party initiating the transaction also will identify the other party, and thus the system will receive a payer identifier for the payer and a payee identifier for the payee. At 302 the system may receive additional information from the payer, the payee, or both, such as preferences, account details, or other information. The system may use this information in step 301 or any of the other steps described in FIG. 3.

At 303 the system will use the payee identifier to identify a payee risk profile for the payee, by accessing a data store and identifying a risk profile having a corresponding identifier. If no such risk profile exists, then the system may create a new payee risk profile for the payee, which the system will then identify and use for the transactions. The payee risk profile model may be run for every transaction the payee accepts in the system. This is because many of the features included in the model are passively collected from the payee's session (e.g., IP address). The model will be optimized if it assesses the risk whenever it is possible that an underlying feature's value changed. The system may require the payee to input certain data that the system will use to build the payee risk profile, as described above in the discussion of FIG. 2. When the payee is a business entity, the machine learning model may evaluate both (1) if the business is a legitimate business entity and (2) if the person registering the business is legitimately associated with the business in a position to register the business and establish payment information on the platform.

At 304 the system identifies one or more global characteristics of each candiate payment rail. The global rail characteristics are characteristics of transactions completed via the rail that are common among all payers and payees and that the payers and payees cannot influence or change. Examples of global rail characteristics include measurements of timeliness of transaction completion, available delivery windows, revocability, and other characteristics. Global rail characteristics may be stored in a data store (such as data store 232 of FIG. 2), entered into the system by a user, received as a message, or otherwise obtained by the system.

At 305 the system will identify a payment origination risk profile for each of the transaction rails, using methods such as those described above for box 232 of FIG. 2. At 306 the system may identify one or more candidate transaction rails via which the payer can send payment to the payee. To do this, the system may identify those that are included in the payer's profile, or consistent with the payer's preference patterns, and also which are able to complete a transaction to any of the payee accounts.

At 307 the system will enter the payee risk profile, the global rail characteristics, and each of the available payment origination risk profiles into a payment method selection model. The payment selection model may be a default model, or the system may select the payment selection model from a group of candidate payment selection models. For example, the system may select, from a data store of candidate payment selection models, a model for which the payer is a unique corresponding entity.

The model may have been trained using preferences of the payer. Alternatively, the payer preferences also may be entered into the model. The payment method selection model will use this information to determine whether one or more of the payee accounts satisfy the payer preferences and/or one or more other risk criteria. If the model determines that more than one of the payment rails satisfy the payer preferences and/or risk criteria, then at 308 the model may classify one of the payment rails as an optimal payment rail via which to complete the transaction. (In the context of this patent document, the term “optimal” does not mean objectively the best by any particular standard, but rather that which a trained model classifies as optimal.) Alternatively, at 308 the system may classify multiple candidate payment rails that most closely satisfy payer preferences and/or risk criteria, and the system may present all such candiate rails to a user for selection of the final rail to be used. When doing so, optionally the system may classify one of the presented rails as optimal and the other rail(s) as alternative(s).

As noted above, the payment method selection model used at 308 may be a transaction-level payment method selection model or a batch-level payment selection model enabled straight-through processing, based on whether the request is for an individual transaction or a batch of transactions.

At 309 the system will use the payee identifier to identify one or more payee accounts at which the payee will accept payment and which as associated with the selected payment rail. To do this, the system may use a payee ID and rail ID to access a data store and identifying accounts having corresponding identifiers. If no such accounts exist in the data store, then the system may ask the payee to enter payee account information to be used.

If multiple payee accounts are available, then at 310 the model may classify one of the payee accounts as an optimal payee account via which to complete the transaction. If multiple candidate payee accounts closely satisfy payer preferences and/or risk criteria, the system may present all such payee accounts to a user for selection at 312. When doing so, optionally the system may classify one of the presented payee accounts as optimal and the other rail(s) as alternative(s).

To do this, the system may use a display or audio speaker to output the optimal payment method (payee account and/or transaction rail) to the payee and/or payor for approval, rejection, or modification.

After the user has indicated acceptance of a payment method (either with or without modification), or after a period of time has elapsed in which the user has not rejected the payment method, then at 312 for the selected payee account (and optinally for one or more alternative payee accounts), the system will identify a payee account risk profile for that payee account. Methods of doing this are described above in the context of the payee risk profile 212 and payee account risk modeling of FIG. 2.

At 313 the system will use the payee account risk profile to validate that the payee account will successfully process on the selected payment rail. If the system cannot validate this, then it may not continue with the transaction. Instead, the system may select an alternative payee account or ask the user to select an alternative account, and the system may then attempt to validate the alternative account. Alternatively or in addition, the system may inform a user that the selected payee account could not be validated.

Once a selected payee account has been validated, then at 314 the system will generate payment initialization data that includes the selected payment method. If the user selects an alternate payee account or payment rail as the payment method, the system may declassify the optimal payee account or transaction rail that the transaction model selected and include the alternate payee account and/or transactional rail in the payment initialization data as the selected payment method. The payment initialization data will be a digital file, a data feed, a message, or other data structure that is be in a format that a financial entity can use to complete the transfer of assets from a payer account that associated with the payer to the selected payee account, using the selected payment rail. At 315 the system will transmit the payment initialization data to the financial institution that holds the payer's account so that the institution can use the file/data feed to initiate the payment via the payment rail.

By way of example, the initialization data may include an instruction file that is an ISO 20022 compliant superset of multiple rail data requirements, enabling processing of all rails from a single system, including but not limited to rail data requirements for a plurality of the following the Clearing House ACH (EPN); the Reserve Banks ACH; Paypal; Zelle; Wire; Virtual Card; Push-to-Debit/Push-to-Card; or The Clearing House RTP.

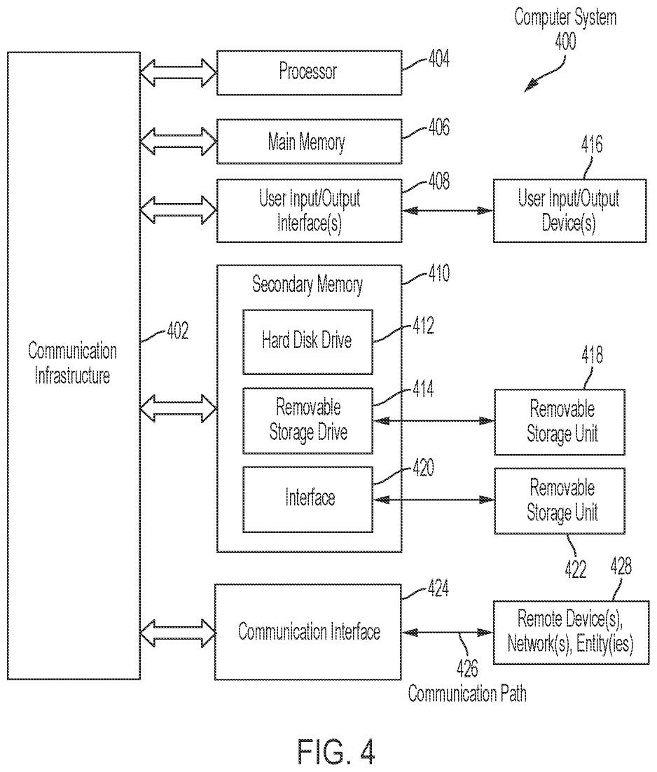

Various embodiments can be implemented, for example, using one or more computer systems, such as computer system 400 shown in FIG. 4. Computer system 400 can be any computer capable of performing the functions described in this document.

Computer system 400 includes one or more processors (also called central processing units, or CPUs), such as a processor 404. Processor 404 is connected to a communication infrastructure or bus 402. Optionally, one or more of the processors 404 may each be a graphics processing unit (GPU). In various embodiments, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 also includes user input/output device(s) 416, such as monitors, keyboards, pointing devices, etc., hat communicate with communication infrastructure 402 through user input/output interface(s) 408.

Computer system 400 also includes a main or primary memory 406, such as random access memory (RAM). Main memory 406 may include one or more levels of cache. Main memory 406 has stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be an external hard drive, a universal serial bus (USB) drive, a memory card such as a compact flash card or secure digital memory, a floppy disk drive, a magnetic tape drive, a compact disc drive, an optical storage device, a tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be an external hard drive, a universal serial bus (USB) drive, a memory card such as a compact flash card or secure digital memory, a floppy disk, a magnetic tape, a compact disc, a DVD, an optical storage disk, and/any other computer data storage device. Removable storage drive 414 reads from and/or writes to removable storage unit 418 in a well-known manner.

According to an example embodiment, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 426, which may be wired and/or wireless, and which may include any combination of LANs, WANs, the Internet, etc. Control logic and/or data may be transmitted to and from computer system 400 via communication path 426.

In some embodiments, a tangible, non-transitory apparatus or article of manufacture comprising a tangible, non-transitory computer useable or readable medium having control logic (software) stored thereon is also referred to in this document as a computer program product or program storage device. This includes, but is not limited to, computer system 400, main memory 406, secondary memory 410, and removable storage units 418 and 422, as well as tangible articles of manufacture embodying any combination of the foregoing. Such control logic, when executed by one or more data processing devices (such as computer system 400), causes such data processing devices to operate as described in this document.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described in this document.

The methods, and systems to implement the methods, described in this document are therefore directed at reducing fraud and errors in digital transactions. The methods are not singular in focus but rather consider a variety of risk scores, profiles, objectives (e.g., lowest cost, fastest settlement), and constraints (e.g., risk tolerance) to select a payment method that the system considers to be the best match to known patterns of payer preferences. This decision is automatically made by a novel machine learning driven process, which takes the decision out of the hands of a human who may be susceptible to fraud and/or social engineering, as well as who may be prone to making errors.

By assessing the complex transaction relationships between payer, payee, and payment methods, the methods described in this document bring transparency to digital transactions. The system uses the transaction as a centroid to trace and recognize patterns in the relationships. The system feeds the features of these relationships into machine learning models to create or maintain risk profiles for the payee, payment method, and payment origination. The machine learning enables anomaly detection by automatically defining the complex patterns of the behaviors of similar payees, features of the payment origination, and behavior of the payment method. The quantification and qualification of these anomalies along with cost and settlement characteristics can provide faster and safer (i.e., fewer errors, lower fraud rate) payment performance.

In addition, the approaches described above, and especially the use of a payment method selection model and/or payee account validation model, allows verification and risk assessment even if the system is presented with missing data. As noted in the Background section above, in networks that do not use open banking, the information available for a potential transaction is often not complete. The methods and systems disclosed in this document may prior to input of data into the model, calculate a conditional probability of fraud and error in the data, thus helping to identify the missing data. This enables the system to provide additional data to models. By transforming missing data to non-missing values, the system may provide both higher fidelity and higher coverage than previous systems. In addition, even if the missing data is not generated, the use of models can provide verification results (such as of “pass” or “fail”), where other systems invention would produce an error because of missing data.

To generate data to take the place of the missing data, the system may transform the known data and feed the transformed data into models that will act on it. The system leverages its storage of risk profiles in a shared memory space (virtual and/or physical memory), and it uses indexes and identifiers to associate entities with each other, and with accounts, on a one-to-one, one-to-many, many-to-one, and/or many-to-many relationships between the entities. Then, the system may fill in missing data for an entity or account with information about a closely associated entity or account. For example, the system may use available data about a person to verify a payment account that is associated with the person.

The system's ability to harmonize data about the transaction, the account, and the payee to address the challenge of missing data is novel. Other systems work in discrete buckets of verification such as verifying a person based on data about that person or verifying a bank account based only on data related to that bank account. The methods and systems disclosed here may calculate a matrix of conditional probabilities, which transforms missing verification elements into probabilistic outcomes that otherwise would be expressed as missing data. By filling in this missing data with substitute and/or transformed data, the methods and systems described here can provide high fidelity verification results more often than current verification approaches can provide.

Terminology that is relevant to this disclosure includes:

An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, digital home assistants and mobile electronic devices such as smartphones, fitness tracking devices, wearable virtual reality devices, Internet-connected wearables such as smart watches and smart eyewear, personal digital assistants, cameras, tablet computers, laptop computers, media players and the like. Electronic devices also may include appliances and other devices that can communicate in an Internet-of-things arrangement, such as smart thermostats, refrigerators, connected light bulbs and other devices. Electronic devices also may include components of vehicles such as dashboard entertainment and navigation systems, as well as on-board vehicle diagnostic and operation systems. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity.

Additional elements that may be included in electronic devices are discussed above in the context of FIG. 4.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “computer-readable medium,” “data store,” “data storage facility” and the like each refer to a non-transitory device on which computer- readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices. The network may include or is configured to include any now or hereafter known communication networks such as, without limitation, a BLUETOOTH® communication network, a Z-Wave® communication network, a wireless fidelity (Wi-Fi) communication network, a ZigBee communication network, a HomePlug communication network, a Power-line Communication (PLC) communication network, a message queue telemetry transport (MQTT) communication network, a MTConnect communication network, a cellular network a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. As such, network 204 may be configured to implement wireless or wired communication through cellular networks, WiFi, BlueTooth, Zigbee, RFID, BlueTooth low energy, NFC, IEEE 802.11, IEEE 802.15, IEEE 802.16, Z-Wave, Home Plug, global system for mobile (GSM), general packet radio service (GPRS), enhanced data rates for GSM evolution (EDGE), code division multiple access (CDMA), universal mobile telecommunications system (UMTS), long-term evolution (LTE), LTE-advanced (LTE-A), MQTT, MTConnect, CoAP, REST API, XMPP, or another suitable wired and/or wireless communication method. The network may include one or more switches and/or routers, including wireless routers that connect the wireless communication channels with other wired networks (e.g., the Internet). The data communicated in the network may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, MTConnect protocol, or any other protocol.

A “machine learning model” or a “model” refers to a set of algorithmic routines and parameters that can predict an output(s) of a real-world process (e.g., prediction of an object trajectory, a diagnosis or treatment of a patient, a suitable recommendation based on a user search query, etc.) based on a set of input features, without being explicitly programmed. A structure of the software routines (e.g., number of subroutines and relation between them) and/or the values of the parameters can be determined in a training process, which can use actual results of the real- world process that is being modeled. Such systems or models are understood to be necessarily rooted in computer technology, and in fact, cannot be implemented or even exist in the absence of computing technology. While machine learning systems utilize various types of statistical analyses, machine learning systems are distinguished from statistical analyses by virtue of the ability to learn without explicit programming and being rooted in computer technology.

An example of a process of using machine learning model may include building a machine learning model from a sample dataset (referred to as a “training set”), evaluating the model against one or more additional sample datasets (referred to as a “validation set” and/or a “test set”) to decide whether to keep the model and to benchmark how good the model is, and then applying the model to make predictions or decisions against live input data received by a system.

The term “optimal”, as used in this document, is a subjective classification in an output of a machine learning model. This means that it is an item that the model classifies as optimal. However, it does not require that the classified item be in fact optimal based on other criteria or in other situations.

The features and functions described above, as well as alternatives, may be combined into many other different systems or applications. Various alternatives, modifications, variations or improvements may be made by those skilled in the art, each of which is also intended to be encompassed by the disclosed embodiments

As described above, this document discloses system, method, and computer program product embodiments for implementing a hybrid spreadsheet and coding environments. The system embodiments include a local computing device, which may have access to one or more remote computing devices. In some embodiments, one or more of the remote computing devices also may be part of the system. The computer program embodiments include programming instructions, stored in a memory device, that are configured to cause a processor to perform the methods described in this document.

Without excluding further possible embodiments, certain example embodiments are summarized in the following clauses:

Clause 1: A method of providing security for a transaction includes, by a processor in response to receiving a payee identifier and information about a transaction from a payer: (a) using use the payee identifier to identify a payee risk profile for the payee; (b) entering the payee risk profile, payer preferences, and global rail characteristics into a payment method selection model that has been trained using preferences of the payer; and (c) using the payment method selection model to determine whether one or more of the candidate payment rails match payer preference patterns, and select one of the one or more candidate payment rails to be a selected payment rail. The method also includes: (d) selecting a payee account that is associated with the payee and the selected payment rail; (e) using a payee account validation model to validate that the payee account will process on the selected payment rail; (f) generate payment initialization data that a financial entity can use to complete a transfer of assets from a payer account that associated with the payer to the selected payee account; and (g) transmitting the payment initialization data to the financial entity to automatically originate the payment from the payer account to the selected payee account via the selected payment rail.

Clause 2: The method of clause 1, further comprising (a) for each of the one or more candidate transaction rails, identifying a payment origination risk profile for that transaction rail, and (b) also entering the payment origination risk profiles into the payment method selection model.

Clause 3: The method of clause 1 or 2, further comprising: (a) receiving, from the payer, a plurality of key-value pairs for one or more payees; (b) entering the key-value pairs into a payee risk profile model to generate assessments of whether the payee satisfies one or more risk criteria; (c) soliciting, from the payer, feedback in response to the assessments; and (d) in response to receiving the feedback, using the feedback to train the payee account validation model.

Clause 4: The method of any of clauses 1-3, wherein using the payment method selection model comprises using a plurality of trained models in an ensemble method

Clause 5: The method of any of clauses 1-4, wherein selecting the payee account comprises causing a display or a speaker to output indicia for a plurality of candidate payee accounts that satisfy one or more risk criteria and, in response to receiving a user selection of one of the candidate payee accounts, using the selected candidate payee account.

Clause 6: The method of any of clauses 1-5 further comprising, in response to determining that the information about the transaction is part of information about a batch of transactions and when using the payment method selection model, using a batch-level model to select, from the one or more candidate transaction rails, a transaction rail that satisfies one or more risk criteria for batch transactions enabled for straight-through processing

Clause 7: The method of any of clauses 1-6 further comprising, in response to determining that the information about the transaction is part of information about a batch of transactions and when using the payment method selection model, using a batch-level model to select, from the one or more candidate transaction rails, a transaction rail that satisfies one or more risk criteria for batch transactions enabled for straight-through processing.

Clause 8: The method of any of clauses 1-7, further comprising: (a) selecting, from a data store of candidate payment selection models, each of which has been trained on data that relates to a unique corresponding entity, the payment method selection model for which the payer is the unique corresponding entity; and (b) using the selected payment method selection model when determining whether one or more of the payee accounts satisfy the one or more risk criteria.

Clause 9: The method of any of clauses 1-8 further comprising, in response to identifying a payment origination profile, entering the payment origination risk profile into the payment method selection model with the payee risk profile.

Clause 10: The method of any of clauses 1-9, wherein, in response to the selected payment rail being an ACH network, generating the payment initialization data comprises generating an ACH file.

Clause 11: The method of any of clauses 1-10, wherein the instructions to select the payee account comprise instructions to, in response to detecting that a plurality of candidate payee accounts are associated with the selected payment rail, classify one of the candidate payee accounts as an optimal payee account to complete the transaction.

Clause 12: A system comprising a processor and a computer-readable medium containing programming instructions that are configured to cause the processor to implement a methods according to any of clauses 1-11.

Clause 13: The system of clause 12, containing programming instructions that are configured to cause the processor to implement the method of clause 5, optionally in combination with any of clauses 2-4 or 6-11, and further comprising the display and the speaker.

Clause 14: The system of clause 12, containing programming instructions that are configured to cause the processor to implement the method of clause 9, optionally in combination with any of clauses 2-8 or 10-11, and further comprising the display and the data store of candidate payment method selection models, each of which has been trained on data that relates to a unique corresponding entity.

Clause 15: A non-transitory computer-readable medium containing programming instructions that are configured to cause a processor to implement a methods according to any of clauses 1-11.

1. A system for providing security for a transaction, the system comprising:
a processor; and
a memory containing programming instructions that are configured to cause the processor to, in response to receiving a payee identifier and information about a transaction from a payer:
use the payee identifier to identify a payee risk profile for the payee enter the payee risk profile, payer preferences, and global rail characteristics into a payment method selection model that has been trained using preferences of the payer,
use the payment method selection model to determine whether one or more of the candidate payment rails match payer preference patterns, and select one of the one or more candidate payment rails to be a selected payment rail,
select a payee account that is associated with the payee and the selected payment rail,
use a payee account validation model to validate that the payee account will process on the selected payment rail,
generate payment initialization data that a financial entity can use to complete a transfer of assets from a payer account that associated with the payer to the selected payee account, and
transmit the payment initialization data to the financial entity to automatically originate the payment from the payer account to the selected payee account on the selected payment rail.

2. The system of claim 1, wherein the instructions to select the payee account comprise instructions to, in response to detecting that a plurality of candidate payee accounts are associated with the selected payment rail, classify one of the candidate payee accounts as an optimal payee account to complete the transaction.

3. The system of claim 1, wherein the programming instructions are also configured to:
for each of the one or more candidate payment rails, identify a payment origination risk profile for that transaction rail; and
also enter the payment origination risk profiles into the payment method selection model.

4. The system of claim 1, further comprising programming instructions that are configured to cause the processor to, before receiving the information about the transaction from the payer:
receive, from the payer, a plurality of key-value pairs for one or more payees;
enter the key-value pairs into a payee risk profile model to generate assessments of whether the payee satisfies one or more risk criteria;
solicit, from the payer, feedback in response to the assessments; and
in response to receiving the feedback, use the feedback to train the payee account validation model.

5. The system of claim 1, wherein the instructions to use the payment method selection model comprise instructions to use a plurality of trained models in an ensemble method.

6. The system of claim 1, wherein:
the system also comprises a display or a speaker; and
the programming instructions to select the payee account comprise instructions to:
cause the display or the speaker to output indicia of a plurality of candidate payee accounts that satisfy one or more risk criteria, and
receive a user selection of one the candidate payee accounts as the selected payee account.

7. The system of claim 1 further comprising programming instructions to, in response to determining that the information about the transaction is part of information about a batch of transactions:
when using the payment method selection model, use a batch-level model to select, from the one or more candidate transaction rails, a transaction rail that satisfies one or more risk criteria for batch transactions enabled for straight-through processing.

8. The system of claim 1, wherein when the payee is a business entity, the payee account validation model is further configured to evaluate one or more of the following:
whether the payment will successfully transmit to the selected payee account via the selected payment rail; or
whether contact information received from the payee for a person is associated with the selected payee.

9. The system of claim 1 further comprising:
a data store of candidate payment method selection models, each of which has been trained on data that relates to a unique corresponding entity; and
additional programming instructions to:
select, from the candidate payment method selection models, the payment method selection model for which the payer is the unique corresponding entity, and
use the selected payment method selection model when determining whether one or more of the candidate payment rails satisfy the payer preference patterns.

10. The system of claim 1, wherein the instructions further comprise instructions to, in response to identifying a payment origination risk profile, enter the payment origination risk profile into the payment method selection model.

11. The system of claim 10, wherein the instructions to enter the payee risk profile into the payment method selection model comprise instructions to enter the payee risk profile into a transaction-level payment method selection model.

12. The system of claim 1, wherein, in response to the selected payment rail being an Automated Clearing House (ACH) network, the instructions to generate the payment instruction file comprise instructions to generate an ACH file.

13. A method of providing security for a transaction, the method comprising:
by a processor, in response to receiving a payee identifier and information about a transaction from a payer:
using the payee identifier to identify a payee risk profile for the payee entering the payee risk profile, payer preferences, and global rail characteristics into a payment method selection model that has been trained using preferences of the payer,
using the payment method selection model to determine whether one or more of the candidate payment rails match payer preference patterns, and select one of the one or more candidate payment rails to be a selected payment rail,
selecting a payee account that is associated with the payee and the selected payment rail,
using a payee account validation model to validate that the payee account will process on the selected payment rail,
generating payment initialization data that a financial entity can use to complete a transfer of assets from a payer account that associated with the payer to the selected payee account, and
transmitting the payment initialization data to the financial entity to automatically originate the payment from the payer account to the selected payee account via the selected payment rail.

14. The method of claim 13, further comprising:
for each of the one or more candidate transaction rails, identifying a payment origination risk profile for that transaction rail; and
also entering the payment origination risk profiles into the payment method selection model.

15. The method of claim 13, further comprising:
receiving, from the payer, a plurality of key-value pairs for one or more payees;
entering the key-value pairs into a payee risk profile model to generate assessments of whether the payee satisfies one or more risk criteria;
soliciting, from the payer, feedback in response to the assessments; and
in response to receiving the feedback, using the feedback to train the payee account validation model.

16. The method of claim 13, wherein using the payment method selection model comprises using a plurality of trained models in an ensemble method.

17. The method of claim 13, wherein selecting the payee account comprises:
causing a display or a speaker to output indicia for a plurality of candidate payee accounts that satisfy one or more risk criteria; and
in response to receiving a user selection of one of the candidate payee accounts, using the selected candidate payee account.

18. The method of claim 13 further comprising, in response to determining that the information about the transaction is part of information about a batch of transactions:
when using the payment method selection model, using a batch-level model to select, from the one or more candidate transaction rails, a transaction rail that satisfies one or more risk criteria for batch transactions enabled for straight-through processing.

19. The method of claim 13, further comprising:
selecting, from a data store of candidate payment selection models, each of which has been trained on data that relates to a unique corresponding entity, the payment method selection model for which the payer is the unique corresponding entity, and
using the selected payment method selection model when determining whether one or more of the payee accounts satisfy the one or more risk criteria.

20. The method of claim 13 further comprising, in response to identifying a payment origination profile, entering the payment origination risk profile into the payment method selection model with the payee risk profile.

21. The method of claim 13, wherein, in response to the selected payment rail being an Automated Clearing House (ACH) network, generating the payment initialization data comprises generating an ACH file.
